(19) United States
(12) Patent Application Publication
(10) Pub. No.: US 2025/0106240 A1
(43) Pub. Date: Mar. 27, 2025

(54) MULTI-TERMINAL COLLABORATIVE DYNAMIC SECURITY ANALYSIS METHOD AND SYSTEM FOR DISTRIBUTED POWER SUPPLY

(71) Applicant: STATE GRID TAIZHOU POWER SUPPLY COMPANY, Taizhou (CN)

(72) Inventors: Zihuai ZHENG, Taizhou (CN); Jianguo QIAN, Taizhou (CN); Xueqi JIN, Taizhou (CN); Zhouhong WANG, Taizhou (CN); Lei HONG, Taizhou (CN); Zihao DAN, Taizhou (CN); Piaohong KONG, Taizhou (CN); Yuande ZHENG, Taizhou (CN); Yizhi ZHU, Taizhou (CN); Kaikai PAN, Taizhou (CN); Wenyuan XU, Taizhou (CN); Yinqiang HUANG, Taizhou (CN)

(21) Appl. No.: 18/730,548

(22) PCT Filed: Sep. 8, 2023
(86) PCT No.: PCT/CN2023/117740

§ 371 Date: Jul. 19, 2024

(30) Foreign Application Priority Data
Sep. 8, 2022 (CN) 202211093291.4

(51) Int. Cl. H04L 9/40; H02J 13/00

(52) U.S. Cl. CPC H04L 63/1433; H02J 13/00002

(57) ABSTRACT

A multi-terminal collaborative dynamic security analysis method and system for distributed power supply are provided. The method includes building a physical-cyber network topology model for a distributed power supply control system; updating cyber domain security risk probabilities and physical domain security risk probabilities of other units, to achieve a dynamic physical-cyber security risk network topology map; searching a target attack path according to different attack entrances and attack intensities; and taking the target attack path as guidance, to implement a damage degree assessment.

This application claims the priority of Chinese Patent Application No. 202211093291.4, filed with the Chinese Intellectual Property Administration on Sep. 8, 2022, the disclosure of which is incorporated herein by reference in its entirety.

### TECHNICAL FIELD

The present application relates to the field of smart grid network security, for example, to a multi-terminal collaborative dynamic security analysis method and system for distributed power supply.

### BACKGROUND

With the promotion and implementation of the dual-carbon strategy and the construction of new type power systems, renewable energy and distributed power supply are experiencing rapid development. Renewable energy has gradually changed from being formerly incremental supplement to the energy and electricity consumption to being incremental main body of the energy and electricity consumption. As the proportion of renewable energy in the total installed capacity continues to increase, the penetration rate of distributed power generation in the power grid has increased significantly, and its network-related performance issues directly affect the stability of the power grid. Among the issues, the application of digital technology and the bidirectional interaction of cyber flow have become an indispensable part of a distributed power supply control system.

The current mainstream distributed power supply control system mainly adopts a region-partitioning strategy. Terminals within a region can communicate with each other and Terminals within different regions can also communicate with each other. The entire control system can affect the main network dispatching control upwards and can control operating status of equipment downwards, such that it is apt to become a gangplank for attacking the power grid. The distributed power generation control system itself may have security risks such as software and hardware vulnerabilities, preset malicious programs and backdoors, and the network environment in which it is located is complex and is apt to be intruded by malicious codes. When the distributed power supply control system encounters an external network attack (such as the BlackEnergy virus) intrusion, its security risks may spread to the main control station system and internal network on the grid side through communication channels, which may threaten the network security of the control and distribution network, and seriously endanger the security of the power system and the stability of the national economy. The large number of units leads to huge amount of power generation and consumption, directly affecting the balance of power supply and demand. Therefore, when multiple distributed power supply control systems are subjected to collaborative action of maliciously manipulated attacks from the Internet of Things (such as MadIoT attacks), the active output and reactive output may be maliciously and significantly changed in a short period of time, which may cause frequency modulation and voltage regulation functions to be falsely triggered, resulting in generator outages, voltage collapse, and line overload within a large region, which may further cause cascading failures or large power grid islanding, forming electric islands and seriously damaging the security and stability of the power grid. The equipment deployment environment is susceptible to external malicious signal, traffic intrusions. Moreover, the distributed control requirements lead to changes in the communication mode of the distributed power supply control systems, gradually transforming from traditional private network “many-to-one” communication to multi-channel “many-to-many” communication, resulting in network topology changes, so that system attack entrances are increased, intrusion pathways are diverse, and security boundaries are blurred, causing severe security risks and endangering the economic and stable operation of the power grid.

### SUMMARY

In a first aspect, a multi-terminal collaborative dynamic security analysis method for distributed power supply is provided in an embodiment of the present application, which includes as follows.

A physical-cyber network topology model for a distributed power supply control system is built by using physical topology connections and communication cyber relationships of all distributed power terminal units.

By using prior knowledge, a cyber domain security risk probability Cᵢ and a physical domain security risk probability Pᵢ of each distributed power terminal unit of the distributed power terminal units are given, and cyber domain impact weights and physical domain impact weights of each distributed power terminal unit on other distributed power terminal units of the distributed power terminal units in the cyber domain and the physical domain are both given, to create a physical-cyber security risk network topology map, specifically, i denotes a distributed power terminal unit.

A cyber domain updating matrix and a physical domain updating matrix are established according to the cyber domain impact weighs and the physical domain impact weights, respectively, and in response to at least one distributed power terminal unit failing or being successfully intruded, cyber domain security risk probabilities and physical domain security risk probabilities of other distributed power terminal units are updated in real time, to dynamically update physical-cyber security risk network topology map.

Based on the dynamically updated physical-cyber security risk network topology map, a target attack path is searched according to different attack entrances and attack intensities.

By taking the target attack path as guidance and taking system index data in a normal state as a reference, system index data in an attacked state is processed and a relational coefficient of each evaluation index is calculated, to assess a business damage degree caused by the target attack path.

In a second aspect, a multi-terminal collaborative dynamic security analysis system for distributed power supply is provided in an embodiment of the present application, which includes a physical-cyber network topology model building module, a security risk network topology map creating module, a dynamically updating module, a target attack path searching module and a business damage degree assessment module.

The physical-cyber network topology model building module is configured to build a physical-cyber network topology model for a distributed power supply control system by using physical topology connections and communication cyber relationships of all distributed power terminal units.

The security risk network topology map creating module is configured to, by using prior knowledge, give a cyber domain security risk probability and a physical domain security risk probability of each distributed power terminal unit of the distributed power terminal units, and give both cyber domain impact weights and physical domain impact weights of each distributed power terminal unit on other distributed power terminal units of the distributed power terminal units in the cyber domain and the physical domain, to create a physical-cyber security risk network topology map, where, i denotes a distributed power terminal unit.

The dynamically updating module is configured to, establish a cyber domain updating matrix and a physical domain updating matrix according to the cyber domain impact weights and the physical domain impact weights, respectively, and in response to at least one distributed power terminal unit failing or being successfully intruded, update cyber domain security risk probabilities and physical domain security risk probabilities of other distributed power terminal units, to dynamically update the physical-cyber security risk network topology map.

The target attack path searching module is configured to, based on the dynamically updated physical-cyber security risk network topology map, search a target attack path according to different attack entrances and attack intensities.

The business damage degree assessment module is configured to, process system index data in an attacked state by taking the target attack path as guidance and taking system index data in a normal state as a reference, calculate a relational coefficient of each evaluation index, to assess a business damage degree caused by the target attack path.

In a third aspect, an electronic device is provided according to an embodiment of the present application, which includes: at least one processor; and a memory configured to store at least one program.

When the at least one program is executed by the at least one processor, the at least one program causes the at least one processor to implement the multi-terminal collaborative dynamic security analysis method for distributed power supply described above.

In a fourth aspect, a computer-readable storage medium is provided according to an embodiment of the present application, which stores a computer program thereon. The computer program, when being executed by a processor, implements the multi-terminal collaborative dynamic security analysis method for distributed power supply described above.

The above content of the present application is only an overview of the technical solutions of the present application. In order to have a clearer understanding of the technical means of the present application, to allow the technical means to be implemented according to the content of the description, and in order to make the above and other objects, features and advantages of the present application more obvious and easy to understand, embodiments of the present application are listed hereinafter.

### BRIEF DESCRIPTION OF DRAWINGS

Throughout the drawings, the same reference numeral is used to denote the same component.

FIG. 1 shows the architecture of a distributed power supply control system according to an embodiment of the present application.

FIG. 2 shows a physical-cyber security risk network topology map according to an embodiment of the present application.

FIG. 3 is a schematic diagram of an attack path drawn in an embodiment of the present application.

FIG. 4 is a flowchart of a multi-terminal collaborative dynamic security analysis method for distributed power supply according to an embodiment of the present application.

FIG. 5 is a schematic structural diagram of an electronic device according to an embodiment of the present application.

### DETAILED DESCRIPTION

The present application is described hereinafter in conjunction with the drawings and embodiments. It is to be noted that all other embodiments obtained by the person of ordinary skill in the art without making creative efforts fall within the scope of protection of the present application.

Before discussing exemplary embodiments in more detail, it is to be noted that some exemplary embodiments are described as processes or methods depicted in the flowchart. Although the flowchart describes various operations (or steps) as a sequential process, many of the operations (or steps) therein may be performed in parallel, concurrently, or simultaneously. Additionally, the order of the operations can be rearranged. The process may be terminated when its operations are completed, but may also have additional steps not included in the drawings. The process may correspond to a method, function, regulation, subroutine, subprogram, or the like.

### First Embodiment

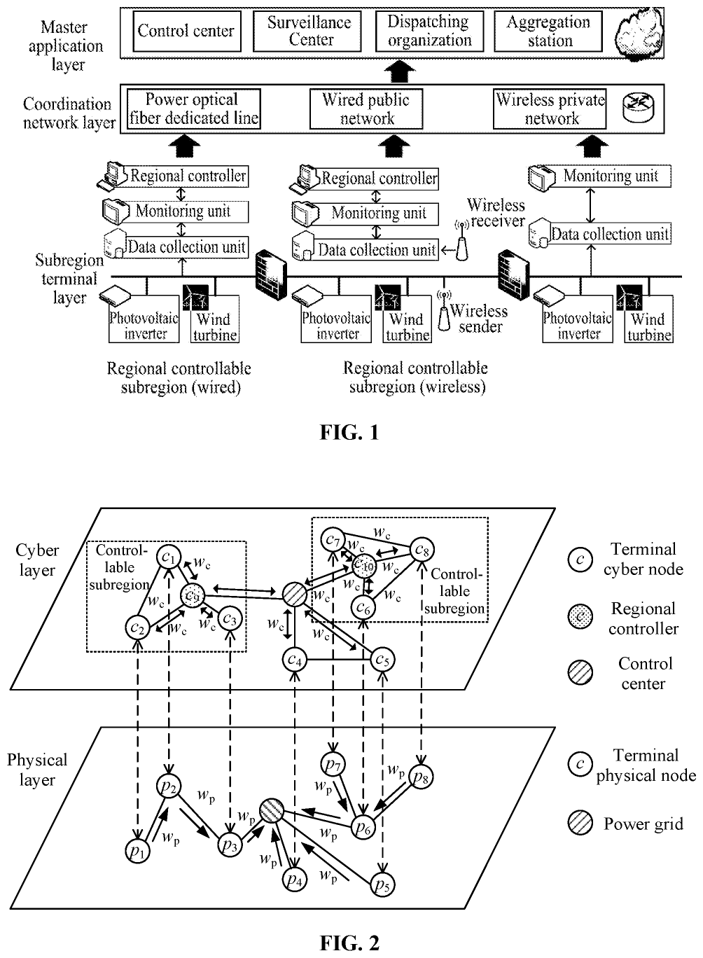

As shown in FIG. 1, in the embodiment of the present application, it intends to build an integrated model of collaborative attack threat subjected by multiple units in a distributed power supply system from multiple perspectives of time and space, to provide a theoretical guidance for system attack risk assessment and security protection. Compared with the conventional power grid system, the distributed power supply system shown in FIG. 1 not only has a practical physical system formed by physical connection of terminal units, but also has a cyber system formed by logical connection of cyber nodes. Since the structures, functions and operation properties of terminals of the distributed power supply cyber system and the practical distributed power supply control system are all different, unified modeling and analysis has become difficult. In the embodiment of the present application, the distributed power supply system is abstracted on the basis of Graph theory and Interdependent networks theory, into a cyber-physical topological structure with inter-network connections, where the inter-network connections represent their coupling relationships, and a weighted correlation matrix is used to formally describe the coupling system.

In this embodiment, the built physical-cyber security risk network topology map is as shown in FIG. 2, where, Cᵢ is a cyber domain security risk probability of a terminal unit i, Pᵢ is a physical domain security risk probability of the terminal unit i, W_{cij} is a cyber domain impact weight between terminal units i and j, and Wₚᵢⱼ is a physical domain impact weight between the terminal units i and j. It is to be noted that the terminal units in the physical domain are not in one-to-one correspondence with the terminal units in the cyber domain, for example, there is a region control node in the cyber domain, but it does not correspond to a practical distributed power supply system terminal unit in the physical domain.

These security risk probabilities are generally obtained from prior knowledge, such as detailed modeling of distributed power terminal units or expert assessment. Here, a relatively simple and common method is list. Apparently, this is not the only way to obtain the risk probabilities.

For example, the distributed power terminal unit may be distributed power generation equipment such as a photovoltaic inverter or a wind turbine, monitoring equipment such as a data collector, and communication control equipment such as a distribution terminal unit (DTU).

The security risk of the terminal units is assessed by using the method of expert assessment. Table 1 gives assessment and assignment criteria of Cᵢ.

TABLE 1
Assessment and assignment criteria of Cᵢ

| Assignment | Description |
|---|---|
| 0.2 | many network security vulnerabilities and |
| | no defensive measures |
| 0.4 | a few network security vulnerabilities and |
| | weak defensive measures |
| 0.6 | few network security vulnerabilities and |
| | strong defensive measures |
| 0.8 | almost no network security vulnerabilities |
| | and perfect defensive measures |

The assessment and assignment of Pᵢ is in the same principle.

Table 2 gives an assessment and assignment criteria of W_{cij}.

TABLE 2
Assessment and assignment criteria of W_{cij}

| Assignment | Description |
|---|---|
| 0.2 | Almost no connection in the cyber |
| | domain (communication, etc.) |
| 0.4 | Less connection in the cyber |
| | domain (communication, etc.) |
| 0.6 | More connection in the cyber |
| | domain (communication, etc.) |
| 0.8 | Close connection in the cyber |
| | domain (communication, etc.) |

The assessment and assignment of Wₚᵢⱼ is in the same principle. It is to be noted that i and j in the impact weights of the cyber domain and physical domain denote serial numbers of the terminal units, for example, Wₚ₁₂ denotes the impact of the first distributed power terminal unit on the second distributed power terminal unit in the physical domain, and since in this embodiment of the present application, it is believed that the mutual impacts between two distributed power terminal units in the physical domain and the cyber domain are the same, and it can be derived:

$${w}_{pij} = {w}_{pji} \\ {w}_{cij} = {w}_{cji}$$

Next, referring to the weighted adjacency matrix in the Graph theory, updating matrices T_{c} and Tₚ are built in the embodiment of the present application as follow:

$${T}_{c} = [ \begin{matrix}{w}_{c 11} & … & {w}_{cn 1} \\ ⋮ & ⋱ & ⋮ \\ {w}_{c 1 n} & … & {w}_{cnn}\end{matrix} ] \\ {T}_{p} = [ \begin{matrix}{w}_{p 11} & … & {w}_{pn 1} \\ ⋮ & ⋱ & ⋮ \\ {w}_{p 1 n} & … & {w}_{pnn}\end{matrix} ]$$

In the formula, n denotes the number of the distributed power terminal units, T_{c} denotes a cyber domain updating matrix, and Tₚ denotes a physical domain updating matrix.

It is different from the conventional weighted adjacency matrix that, in the conventional graph theory, the weight of two unconnected points is generally taken as infinity, while the weight of the same node is taken as 0, that is:

$$\{ \begin{matrix}{w}_{ij} = ∞ & i , {j}_{not adjacent} \\ {w}_{ij} = 0 & i = j\end{matrix} .$$

However, the weight in the physical-cyber security risk network topology map in the embodiment of the present application represents the degree of mutual impact of power terminals. If two nodes are not connected to each other, it means that they have no mutual impact on each other, and the weight should be zero. In order to facilitate the subsequent updating of risk probability, the weight of the same node is also taken as 0, that is:

$$\{ \begin{matrix}{w}_{ij} = 0 & i , {j}_{not adjacent} \\ {w}_{ij} = 0 & i = j\end{matrix} .$$

After the updating matrices T_{c} and Tₚ are built, the cyber domain security risk probability Cᵢ and the physical domain security risk probability Pᵢ in the physical-cyber security risk network topology map can be updated in real time in the embodiment of the present application.

A matrix S_{c} is defined as a state matrix indicating whether nodes are subjected to network intrusions, and a matrix Sₚ is defined as a state matrix indicating whether the nodes are subjected to physical damages, that is:

$${S}_{c} = [ \begin{matrix}{s}_{c 1} \\ ⋮ \\ {s}_{cn}\end{matrix} ]$$

where S_{ci}=0 means that the terminal unit i is not subjected to a network intrusion, and S_{ci}=1 means that the terminal unit i is subjected to a network intrusion.

$${S}_{p} = [ \begin{matrix}{s}_{p 1} \\ ⋮ \\ {s}_{pn}\end{matrix} ]$$

where Sₚᵢ=0 means that the terminal unit i is not subjected to a physical damage, and Sₚᵢ=1 means that the terminal unit i is subjected to a physical damage.

Security risk probabilities are updated in the follow ways:

$$C = {T}_{c} \cdot {S}_{c} + C \\ P = {T}_{p} \cdot {S}_{p} + P$$

where, C and P are matrices containing the risk probabilities of all nodes, namely:

$$C = [ \begin{matrix}{c}_{1} \\ ⋮ \\ {c}_{n}\end{matrix} ] \\ P = [ \begin{matrix}{p}_{1} \\ ⋮ \\ {p}_{n}\end{matrix} ]$$

After the updated security risks mode is obtained, flexible choosing of attack entrances and attack intensities can be provided in the embodiment of the present application. Decision makers can arbitrarily choose the attack entrance they desired and set a risk threshold ε. The risk threshold here is divided into a physical domain risk threshold εₚ and a cyber domain risk threshold ε_{c}. After the attack entrance and the risk threshold are set, the following two steps will be repeated until the attack path does not continue to change.
a. Whether a physical domain/cyber domain risk probability of a node connected to a node on an attack path exceeds a security risk threshold. If the physical domain/cyber domain risk probability of the node exceeds the threshold, the node is included into the attack path and a state value in the state matrix is set to 1, that is:

$$\{ \begin{matrix}{s}_{ci} = 1 , & if {c}_{i} > {ε}_{c} \\ {s}_{pi} = 1 , & if {p}_{i} > {ε}_{p}\end{matrix}$$

b. Security risk probabilities of each node are updated through the updating matrices.

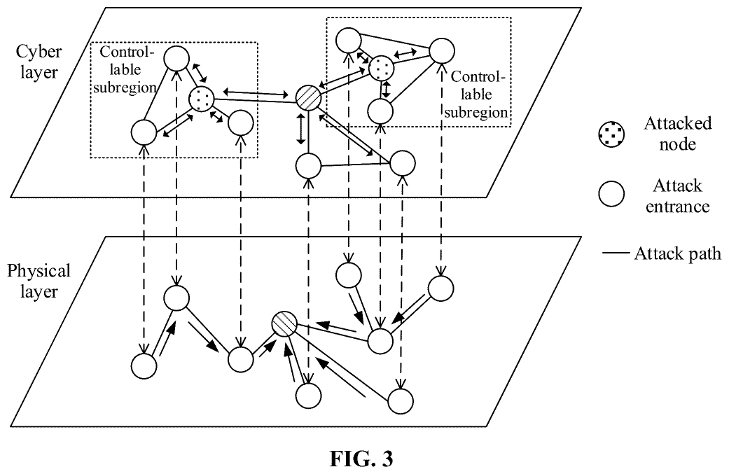

It is to be noted that in the embodiment of the present application, not only one node can be chosen as the attack entrance, considering that when there are multiple nodes being attacked, the risk of the node originally safe will be significantly increased, an attack path of collaborative attacks for multiple units may further be analyzed in the embodiment of the present application. The schematic diagram of the attack path is as shown in FIG. 3.

After the attack path is obtained, a business damage degree caused by the attack is further assessed in the embodiment of the present application. The method for assessing the business damage degree includes steps as follows.

### 1) Choosing of Evaluation Indexes

For different types of power terminal units on different attack paths, different damage degree evaluation indexes are required to be selected, the selected indexes must reflect the performance properties of normal work of the target system under specific business scenarios. Therefore, the evaluation indexes are required to have the following properties: a. Targeted. The evaluation indexes are required to include all properties of all possible attack target systems. In the embodiment of the present application, by taking into consideration the typical scenarios of the distributed power supply system, the distributed power supply system may be defined as a cyber-physical system, and evaluation indexes may be extracted from three dimensions: cyber system operation, physical system operation and business based on the cyber-physical system. b. Measurability. It should be ensured that the indexes can be expressed quantitatively or qualitatively, and that accurate data corresponding to the indexes can be obtained through collection tools and mathematical calculation means, and if an index, though being effective, has poor operability, the index should be discarded. c. Completeness. The indexes are required to be able to cover all performances of the target system, that is, to reflect changes in all aspects of the system after being attacked as compared with before being attacked, and to reflect the attack effects of all types of attacks. In this embodiment, the evaluation indexes may be selected as the power generation amount of a terminal unit, the importance degree of the terminal unit, the number of other unit nodes connected to the terminal unit, etc.

### 2) Index Data Processing

After the evaluation indexes are selected, index data for the system in a normal state and index data for the system being inputted with different attack sequences are collected, and values of a series of collected index data are as shown in the following formula:

$$X = ( {X}_{1} , {X}_{2} , … , {X}_{N} ) = [ \begin{matrix}{x}_{1} ( 1 ) & … & {x}_{n} ( 1 ) \\ ⋮ & ⋱ & ⋮ \\ {x}_{1} ( m ) & … & {x}_{n} ( m )\end{matrix} ]$$

where, X is a system set for the system in different states, N is the number of the different states, and Xᵢ is a system index vector in an i^{th} state, as shown in the following formula:

$${X}_{i} = {( {x}_{i} ( 1 ) , {x}_{i} ( 2 ) … {x}_{i} ( m ) )}^{T}$$

where, m is the number of evaluation indexes, and xᵢ(m) denotes data of an m^{th} index in the i^{th} state. The system states can be customized according to the types of the system and terminal units.

### 3) Index Weight Determining

In the embodiment of the present application, a method that combines the grey relational analysis and the analytic hierarchy process is used to calculate an index weight. First, reference data is set, that is, optimal values of the system indexes are taken as a reference data array, a dimensionality reduction transformation is performed on the reference data array, and the result is as follows:

$${X}_{0} = {( {x}_{0} ( 1 ) , {x}_{0} ( 2 ) … {x}_{0} ( m ) )}^{T}$$

where, X₀ denotes a system reference index vector, and x₀(m) denotes a reference value of the m^{th} index;

Then, absolute values of differences between the reference data and the evaluation indexes in each state are calculated, that is,

$$Δ = \vert {x}_{0} ( k ) - {x}_{i} ( k ) \vert , k = 1 , 2 … m , i = 1 , 2 … N$$

where, xᵢ(k) denotes the value of a k^{th} evaluation index in the i^{th} state; and it is determined whether xᵢ(k) exceeds an upper limit and a lower limit of the threshold. If xᵢ(k) is within the threshold, Δ is written into a subordinate assessment set.

Secondly, relative importance degrees of the indexes are determined through the analytic hierarchy process, that is, a distinguishing coefficient is determined. According to the analytic hierarchy process, first, the indexes are stratified, and importance level table is built between indexes of the same class at the same level, to determine the relative importance between every two indexes to form a pairwise comparison matrix (that is, a judgement matrix). Consistency of the matrix is checked. If the matrix meets the consistency, the matrix eigenvector is the weight of the indexes at this level. The weights are accumulated according to the classification. Finally, the weights of all the indexes against the top level are obtained, that is, the distinguishing coefficient, recorded as ρₖ.

Furthermore, a relational coefficient is calculated for each evaluation index, that is

$${γ}_{i} ( k ) = \frac{{min}_{i} Δ + {ρ}_{k} \cdot {max}_{i} Δ}{Δ + {ρ}_{k} \cdot {max}_{i} Δ} , k = 1 , 2 … m , i = 1 , 2 … N$$

where, γᵢ(k) denotes the relational coefficient of the k^{th} evaluation index in the i^{th} state, and maxᵢΔ denotes the maximum value in absolute values of differences in the i^{th} state, and minᵢΔ denotes the minimum value in absolute values of differences in the i^{th} state.

Finally, the weighted mean of the relational coefficients between the evaluation indexes and the corresponding elements of the reference sequence in each scenario is calculated to obtain the correlation between the attack result and the reference sequence, and according to the subordinate assessment set, low weights are assigned to the subordinate indexes. Here, the analytic hierarchy process may be used again on the basis of subjective judgment to re-assign the weighted values of the evaluation indexes, the weighted values are recorded as wᵢₖ, and the finally obtained a business damage assessment result is shown as the following formula:

$${Degree}_{0 i} = \frac{1}{m} {\sum }_{k = 1}^{m} {w}_{i k} {γ}_{i} ( k )$$

where, Degree₀ᵢ denotes the business damage degree in the i^{th} state of the system, and wᵢₖ denotes the weight of the k^{th} evaluation index in the i^{th} state.

### Second Embodiment

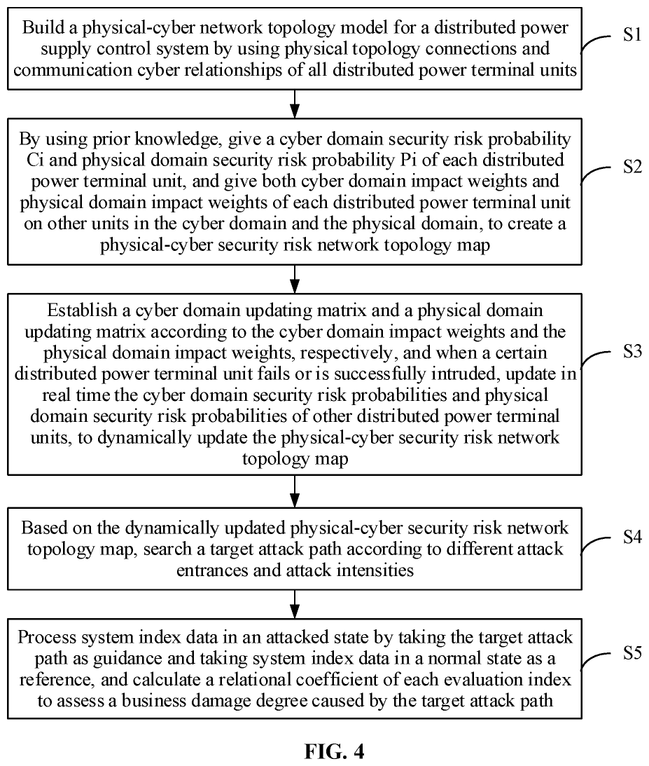

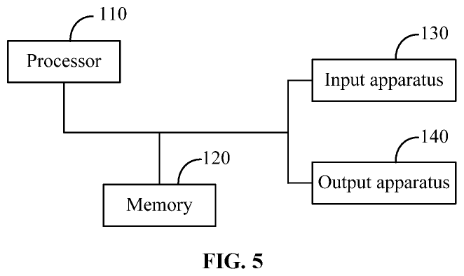

Referring to FIG. 4, a multi-terminal collaborative dynamic security analysis method for distributed power supply is provided according to the embodiment of the present application, which includes steps S1, S2, S3, S4 and S5.

In S1, a physical-cyber network topology model for a distributed power supply control system is built by using physical topology connections and communication cyber relationships of all distributed power terminal units.

In S2, by using prior knowledge, a cyber domain security risk probability Cᵢ and physical domain security risk probability Pᵢ of each distributed power terminal unit are given, and cyber domain impact weights and physical domain impact weights of each distributed power terminal unit on other units in the cyber domain and the physical domain are both given, to create a physical-cyber security risk network topology map.

In S3, a cyber domain updating matrix and a physical domain updating matrix are established according to the cyber domain impact weights and the physical domain impact weights, respectively, and when a certain distributed power terminal unit fails or is successfully intruded, cyber domain security risk probabilities and physical domain security risk probabilities of other distributed power terminal units are updated in real time, to dynamically update the physical-cyber security risk network topology map.

In S4, based on the dynamically updated physical-cyber security risk network topology map, a target attack path is searched according to different attack entrances and attack intensities.

In S5, system index data in an attacked state is processed by taking the target attack path as guidance and taking system index data in a normal state as a reference, a relational coefficient of each evaluation index is calculated, to assess a business damage degree caused by the target attack path.

In an example, the physical-cyber network topology model for a distributed power supply control system includes topology relationships of power terminal units, while the physical-cyber security risk network topology map includes relationships and weights of mutual impacts between the units in addition to the topology relationships of the units.

### Third Embodiment

Corresponding to the embodiment of the multi-terminal collaborative dynamic security analysis method for low-voltage distributed power supply described above, a multi-terminal collaborative dynamic security analysis system for low-voltage distributed power supply is further provided according to an embodiment of the present application, which includes: a physical-cyber network topology model building module, a security risk network topology map creating module, a dynamically updating module, a target attack path searching module and a business damage degree assessment module.

The physical-cyber network topology model building module is configured to build a physical-cyber network topology model for a distributed power supply control system by using physical topology connections and communication cyber relationships of all distributed power terminal units.

The security risk network topology map creating module is configured to, by using prior knowledge, give a cyber domain security risk probability and a physical domain security risk probability of each distributed power terminal unit, and give both cyber domain impact weights and physical domain impact weights of each distributed power terminal unit on other distributed power terminal units in the cyber domain and the physical domain, to create a physical-cyber security risk network topology map.

The dynamically updating module is configured to, establish a cyber domain updating matrix and a physical domain updating matrix according to the cyber domain impact weights and the physical domain impact weights, respectively, and when a certain distributed power terminal unit fails or is successfully intruded, update the cyber domain security risk probabilities and physical domain security risk probabilities of the other distributed power terminal units in real time, to dynamically update the physical-cyber security risk network topology map.

The target attack path searching module is configured to, based on the dynamically updated physical-cyber security risk network topology map, search a target attack path according to different attack entrances and attack intensities.

The business damage degree assessment module is configured to, process system index data in an attacked state by taking the target attack path as guidance and taking system index data in a normal status as a reference, and, calculate a relational coefficient of each evaluation index, to assess a business damage degree caused by the target attack path.

Regarding the system in the embodiment described above, the specific manners in which the modules perform operations have been described in detail in the method embodiment, and are not described in detail here.

For the system embodiment, since it basically corresponds to the method embodiment, reference may be made to the description of the part of the method embodiment for relevant details. The system embodiment described above is only illustrative, and the dynamically updating module may be or may not be physically separated. In addition, the functional modules in the embodiment of the present application can be integrated into a processing unit, or the modules can present physically separately, or two or more modules can be integrated into one unit. The above-mentioned integrated modules or units can be implemented in the form of hardware or software functional units, to select some or all of the modules according to practical requirements to achieve the object of the solution of this application.

The multi-terminal collaborative dynamic security analysis method and system for distributed power supply are provided according to the embodiments of the present application, with which, an integrated model of collaborative attack threat subjected by multiple units of a distributed power supply control system is built from multiple perspectives of time and space. According to the embodiments of the present application, cyber connection relationships, physical connection relationships between units of the distributed power supply control system and a coupling relationship between the cyber connection relationship and the physical connection relationship are constructed first to build a physical-cyber network topology model for the distributed power supply system, to provide support for the attack threat modeling of the distributed power supply system; moreover, formal description method of system attacks is built according to the differences of the time and space distribution when the distributed power supply system is attacked.

FIG. 5 is a schematic structural diagram of an electronic device according to an embodiment of the present application, as shown in FIG. 5, and the electronic device includes one or more processors 110 and a memory 120. One processor 110 is provided in FIG. 5 for illustration.

The electronic device may further include an input apparatus 130 and an output apparatus 140.

The processor 110, the memory 120, the input apparatus 130 and the output apparatus 140 in the electronic device may be connected by a bus or otherwise, and are connected by a bus in FIG. 5 for illustration.

As a computer-readable storage medium, the memory 120 may be configured to store software programs, computer-executable programs and modules. The processor 110 runs the software programs, instructions and modules stored in the memory 120 to execute multiple function applications and data processing so as to implement any method in the embodiments described above.

The memory 120 may include a program storage region and a data storage region. The program storage region may store an operating system and an application program required by at least one function. The data storage region may store data created according to the use of the electronic device. In addition, the memory may include a volatile memory such as a random-access memory (RAM) and may also include a nonvolatile memory such as at least one click memory, a flash memory, or other non-transient solid-status memories.

The memory 120 may be a non-transitory computer storage medium or a transitory computer storage medium. The non-transient computer storage medium is, for example, at least one disk memory unit, flash memory unit, or other non-volatile solid status memory units. In some embodiments, the memory 120 optionally includes memories which are disposed remotely relative to the processor 110. These remote memories may be connected to the electronic device via a network. The examples of the network may include the Internet, an enterprise intranet, a local area network, a mobile communication network and their combination.

The input apparatus 130 may be configured to receive input digital or character information and generate signal input related to user settings and function control of the electronic device. The output apparatus 140 may include a display unit such as a display screen.

In one example, the electronic device may also not include the input apparatus 130 and the output apparatus 140.

In one example, the electronic device may be a server.

A computer-readable storage medium is further provided according to this embodiment, which stores thereon a computer program for performing the above-described method.

The storage medium may be a non-transitory storage medium.

All or part of the procedures in the method according to the embodiments described above may be performed by related hardware implementing a computer program, the program may be stored in a non-transient computer-readable storage medium, and the program, when being executed, may include the procedure in the method embodiment described above. The non-transient computer-readable storage medium may be a magnetic disk, an optical disk, a read-only memory (ROM), or an RAM.

Characteristics of the embodiments of the present application are listed as follows.
(1) In the embodiments of the present application, units of the distributed power supply control system are modeled in both cyber domain and physical domain, which well addresses the security risks possibly present under strong coupling and structure complicated of system business but may be ignored by general risk assessment such as multiple terminals being coordinately attacked.
(2) In the embodiments of the present application, the risk probability updating matrices are built, the security risk probabilities in the system security risk topology map are updated in real time, and dynamic security risk analysis is implemented. When the system is attacked, guidance may be provided for engineers in performing security operations such as isolating some units or cutting off communication of some units, and moreover establishing an attack path is facilitated.
(3) In the embodiments of the present application, risk threshold εcan be flexibly set to achieve attacks of different attacking intensities and set up different attack paths, which provides guidance for the decision maker to establish most effective protection measures and systems under the limited cost. In the case of limited cost, the decision-maker can set the risk threshold higher, to defense against the obtained attack paths with higher risks.
(4) In the embodiments of the present application, a complete risk analysis scheme is provided, which not only makes certain the attack path, but also analyzes the business damage degree caused by the attack path, and clarifies the consequences which may be caused by the attack. With this analysis, the decision-maker can reduce some security defense cost inputs against certain security risk which is large but may not cause serious consequences.

The scope of the present application includes but is not limited to the embodiments of the present application, and equivalent variations made according to the shape and structure of the present application are within the protection scope of the present application.

1. A multi-terminal collaborative dynamic security analysis method for distributed power supply, comprising:
building a physical-cyber network topology model for a distributed power supply control system by using physical topology connections and communication cyber relationships of all distributed power terminal units;
by using prior knowledge, giving a cyber domain security risk probability Cᵢ and a physical domain security risk probability Pᵢ of each distributed power terminal unit of the distributed power terminal units, and giving cyber domain impact weights and physical domain impact weights of each distributed power terminal unit on other distributed power terminal units of the distributed power terminal units in the cyber domain and the physical domain, to create a physical-cyber security risk network topology map, wherein i denotes a distributed power terminal unit;
establishing a cyber domain updating matrix and a physical domain updating matrix according to the cyber domain impact weights and the physical domain impact weights, respectively, and in response to at least one distributed power terminal unit failing or being successfully intruded, updating cyber domain security risk probabilities and physical domain security risk probabilities of the other distributed power terminal units, to dynamically update the physical-cyber security risk network topology map;
based on the dynamically updated physical-cyber security risk network topology map, searching a target attack path according to different attack entrances and attack intensities; and
processing system index data in an attacked state by taking the target attack path as guidance and taking system index data in a normal state as a reference, and calculating a relational coefficient of each evaluation index, to assess a business damage degree caused by the target attack path.

2. The multi-terminal collaborative dynamic security analysis method for distributed power supply according to claim 1, wherein the cyber domain updating matrix and the physical domain updating matrix are:
$${T}_{c} = [ \begin{matrix}{w}_{c 11} & … & {w}_{c n 1} \\ ⋮ & {w}_{cij} & ⋮ \\ {w}_{c 1 n} & … & {w}_{cnn}\end{matrix} ]$$
$${T}_{c} = [ \begin{matrix}{w}_{p 11} & … & {w}_{p n 1} \\ ⋮ & {w}_{pij} & ⋮ \\ {w}_{p 1 n} & … & {w}_{pnn}\end{matrix} ]$$
wherein, T_{c} is the cyber domain updating matrix, Tₚ is the physical domain updating matrix, w_{cij} is a cyber domain impact weight between distributed power terminal unit i and distributed power terminal unit j, wₚᵢⱼ is a physical domain impact weight between the distributed power terminal unit i and the distributed power terminal unit j, and n denotes the number of distributed power terminal units.

3. The multi-terminal collaborative dynamic security analysis method for distributed power supply according to claim 2, wherein update formulas of the cyber domain security risk probability and the physical domain security risk probability are:
$$C = {T}_{c} \cdot {S}_{c} + C$$
$$P = {T}_{p} \cdot {S}_{p} + P$$
wherein, C is a cyber domain security risk probability matrix of the all distributed power terminal units, P is a physical domain security risk probability matrix of the all distributed power terminal units; S_{c} is a network intrusion matrix, used to indicate whether the distributed power terminal units are subjected to network intrusion; and Sₚ is a physical impact matrix, used to indicate whether the distributed power terminal units are subjected to physical damage.

4. The multi-terminal collaborative dynamic security analysis method for distributed power supply according to claim 1, wherein a searching method for the target attack path is:
taking an attack entrance as a starting point, determining whether a cyber domain security risk probability or a physical domain security risk probability of a distributed power terminal unit connected to a distributed power terminal unit on an attack path exceeds a risk threshold, and in response to the cyber domain security risk probability or the physical domain security risk probability of the distributed power terminal unit connected to the distributed power terminal unit on the attack path exceeds the risk threshold, taking the distributed power terminal unit connected to the distributed power terminal unit on the attack path into the attack path, and setting a state value in a state matrix to 1, that is:
$$\{ \begin{matrix}{s}_{c i} = 1 , if {c}_{i} > {ε}_{c} \\ {s}_{p i} = 1 , if {p}_{i} > {ε}_{p}\end{matrix}$$
wherein, the state matrix comprises a network intrusion matrix and a physical impact matrix;
wherein, the network intrusion matrix is:
$${S}_{c} = [ \begin{matrix}{S}_{c 1} \\ ⋮ \\ {S}_{cn}\end{matrix} ] ;$$
wherein, the physical impact matrix is:
$${S}_{p} = [ \begin{matrix}{S}_{p 1} \\ ⋮ \\ {S}_{pn}\end{matrix} ] ;$$
wherein, Cᵢ is a cyber domain security risk probability of a distributed power terminal unit i, and Pᵢ is a physical domain security risk probability of the distributed power terminal unit i;
wherein, ε_{c} is a cyber domain risk threshold, and εₚ is a physical domain risk threshold;
updating the cyber domain security risk probability or the physical domain security risk probability of the distributed power terminal units through the updated state matrix; and
repeating the operations of taking an attack entrance as a starting point, determining whether a cyber domain security risk probability or a physical domain security risk probability of a distributed power terminal unit connected to a distributed power terminal unit on an attack path exceeds a risk threshold, to the operation of updating the cyber domain security risk probability or the physical domain security risk probability of the distributed power terminal units through the updated state matrix, till the attack path does not continue to change.

5. The multi-terminal collaborative dynamic security analysis method for distributed power supply according to claim 1, wherein a method for assessing a business damage degree comprises:
defining evaluation indexes;
collecting index data of the evaluation indexes for the system in a normal state and index data for the system being inputted with different target attack paths, and values of the collected index data for the system being inputted with different target attack paths are as shown in the following formula:
$$X = ( {X}_{1} , {X}_{2} , … , {X}_{N} ) = [ \begin{matrix}{x}_{1} ( 1 ) & … & {x}_{n} ( 1 ) \\ ⋮ & ⋱ & … \\ {x}_{1} ( m ) & … & {x}_{n} ( m )\end{matrix} ]$$
wherein, X is a system set for the system in different states, N is the number of the different states, m is the number of the evaluation indexes, and Xᵢ is a system index vector in an i^{th} state, as shown in the following formula:
$${X}_{i} = {( {x}_{i} ( 1 ) , {x}_{i} ( 2 ) , … , {x}_{i} ( k ) , … , {x}_{i} ( m ) )}^{T}$$
wherein, xᵢ(k) denotes a value of a k^{th} evaluation index in the i^{th} state;
taking the index data for the system in the normal state as a system reference index vector, and calculating absolute values of differences between a reference value in the system reference index vector and values of the evaluation indexes in each state,
$$Δ = \vert {x}_{0} ( k ) - {x}_{i} ( k ) \vert , k = 1 , 2 … m , i = 1 , 2 … N$$
$${X}_{0} = {( {x}_{0} ( 1 ) , {x}_{0} ( 2 ) , … , {x}_{0} ( k ) , … , {x}_{0} ( m ) )}^{T}$$
wherein, X₀ denotes the system reference index vector, x₀(k) denotes a reference value of the k^{th} evaluation index, xᵢ(k) denotes a value of the k^{th} evaluation index in the i^{th} state;
determining whether xᵢ(k) exceeds an upper limit and a lower limit of a threshold, and in response that xᵢ(k) is within the threshold, writing Δ into a subordinate assessment set;
calculating a relational coefficient of each evaluation index of the evaluation indexes,
$${γ}_{i} ( k ) = \frac{{min}_{i} Δ + {ρ}_{k} \cdot {max}_{i} Δ}{Δ + {ρ}_{k} \cdot {max}_{i} Δ} , k = 1 , 2 … m , i = 1 , 2 … N$$
wherein, γᵢ(k) denotes a relational coefficient of the k^{th} evaluation index in the i^{th} state, ρₖ is an importance degree of the k^{th} evaluation index and maxᵢΔ denotes a maximum value in the absolute values of differences in the i^{th} state; and
calculating the business damage degree:
$${Degree}_{0 i} = \frac{1}{m} {\sum }_{k = 1}^{m} {w}_{i k} {γ}_{i} ( k )$$
wherein, Degree₀ᵢ denotes the business damage degree in the i^{th} state of the system, and wᵢₖ denotes a weight of the k^{th} evaluation index in the i^{th} state.

6. (canceled)

7. An electronic device comprising:
at least one processor; and
a memory configured to store at least one program, wherein
the at least one program, when being executed by the at least one processor, causes the at least one processor to implement the multi-terminal collaborative dynamic security analysis method for distributed power supply according to claim 1.

8. A non-transitory computer-readable storage medium, storing a computer program thereon, wherein, the computer program, when being executed by a processor, implements the multi-terminal collaborative dynamic security analysis method for distributed power supply according to claim 1.

9. The electronic device according to claim 7, wherein the cyber domain updating matrix and the physical domain updating matrix are:
$${T}_{c} = [ \begin{matrix}{w}_{c 11} & … & {w}_{c n 1} \\ ⋮ & {w}_{cij} & ⋮ \\ {w}_{c 1 n} & … & {w}_{cnn}\end{matrix} ]$$
$${T}_{p} = [ \begin{matrix}{w}_{p 11} & … & {w}_{p n 1} \\ ⋮ & {w}_{pij} & ⋮ \\ {w}_{p 1 n} & … & {w}_{pnn}\end{matrix} ]$$
wherein, T_{c} is the cyber domain updating matrix, Tₚ is the physical domain updating matrix, w_{cij} is a cyber domain impact weight between distributed power terminal unit i and distributed power terminal unit j, Wₚᵢⱼ is a physical domain impact weight between the distributed power terminal unit i and the distributed power terminal unit j, and n denotes the number of distributed power terminal units.

10. The electronic device according to claim 9, wherein update formulas of the cyber domain security risk probability and the physical domain security risk probability are:
$$C = {T}_{c} \cdot {S}_{c} + C$$
$$P = {T}_{p} \cdot {S}_{p} + P$$
wherein, C is a cyber domain security risk probability matrix of the all distributed power terminal units, P is a physical domain security risk probability matrix of the all distributed power terminal units; S_{c} is a network intrusion matrix, used to indicate whether the distributed power terminal units are subjected to network intrusion; and Sₚ is a physical impact matrix, used to indicate whether the distributed power terminal units are subjected to physical damage.

11. The electronic device according to claim 7, wherein a searching method for the target attack path is:
taking an attack entrance as a starting point, determining whether a cyber domain security risk probability or a physical domain security risk probability of a distributed power terminal unit connected to a distributed power terminal unit on an attack path exceeds a risk threshold, and in response to the cyber domain security risk probability or the physical domain security risk probability of the distributed power terminal unit connected to the distributed power terminal unit on the attack path exceeds the risk threshold, taking the distributed power terminal unit connected to the distributed power terminal unit on the attack path into the attack path, and setting a state value in a state matrix to 1, that is:
$$\{ \begin{matrix}{s}_{c i} = 1 , if {c}_{i} > {ε}_{c} \\ {s}_{p i} = 1 , if {p}_{i} > {ε}_{p}\end{matrix}$$
wherein, the state matrix comprises a network intrusion matrix and a physical impact matrix;
wherein, the network intrusion matrix is:
$${S}_{c} = [ \begin{matrix}{S}_{c 1} \\ ⋮ \\ {S}_{cn}\end{matrix} ] ;$$
wherein, the physical impact matrix is:
$${S}_{p} = [ \begin{matrix}{S}_{p 1} \\ ⋮ \\ {S}_{pn}\end{matrix} ] ;$$
wherein, Cᵢ is a cyber domain security risk probability of a distributed power terminal unit i, and Pᵢ is a physical domain security risk probability of the distributed power terminal unit i;
wherein, ε_{c} is a cyber domain risk threshold, and εₚ is a physical domain risk threshold;
updating the cyber domain security risk probability or the physical domain security risk probability of the distributed power terminal units through the updated state matrix; and
repeating the operations of taking an attack entrance as a starting point, determining whether a cyber domain security risk probability or a physical domain security risk probability of a distributed power terminal unit connected to a distributed power terminal unit on an attack path exceeds a risk threshold, to the operation of updating the cyber domain security risk probability or the physical domain security risk probability of the distributed power terminal units through the updated state matrix, till the attack path does not continue to change.

12. The electronic device according to claim 7, wherein a method for assessing a business damage degree comprises:
determining evaluation indexes;
collecting index data of the evaluation indexes for the system in a normal state and index data for the system being inputted with different target attack paths, and values of the collected index data for the system being inputted with different target attack paths are as shown in the following formula:
$$X = ( {X}_{1} , {X}_{2} , … , {X}_{N} ) = [ \begin{matrix}{x}_{1} ( 1 ) & ⋯ & {x}_{n} ( 1 ) \\ ⋮ & ⋱ & ⋮ \\ {x}_{1} ( m ) & ⋯ & {x}_{n} ( m )\end{matrix} ]$$
wherein, X is a system set for the system in different states, N is the number of the different states, m is the number of the evaluation indexes, and Xᵢ is a system index vector in an i^{th} state, as shown in the following formula:
$${X}_{i} = {( {x}_{i} ( 1 ) , {x}_{i} ( 2 ) , … , {x}_{i} ( k ) , … , {x}_{i} ( m ) )}^{T}$$
wherein, xᵢ(k) denotes a value of a k^{th} evaluation index in the i^{th} state;
taking the index data for the system in the normal state as a system reference index vector, and calculating absolute values of differences between a reference value in the system reference index vector and values of the evaluation indexes in each state,
$$Δ = \vert {x}_{0} ( k ) - {x}_{i} ( k ) \vert , k = 1 , 2 … m , i = 1 , 2 … N \\ {X}_{0} = {( {x}_{0} ( 1 ) , {x}_{0} ( 2 ) , … , {x}_{0} ( k ) , … , {x}_{0} ( m ) )}^{T}$$
wherein, X₀ denotes the system reference index vector, x₀(k) denotes a reference value of the k^{th} evaluation index, xᵢ(k) denotes a value of the k^{th} evaluation index in the i^{th} state;
determining whether xᵢ(k) exceeds an upper limit and a lower limit of a threshold, and in response that xᵢ(k) is within the threshold, writing Δ into a subordinate assessment set;
calculating a relational coefficient of each evaluation index of the evaluation indexes,
$${γ}_{i} ( k ) = \frac{{min}_{i} Δ + {ρ}_{k} \cdot {max}_{i} Δ}{Δ + {ρ}_{k} \cdot {max}_{i} Δ ,} , k = 1 , 2 … m , i = 1 , 2 … N$$
wherein, γᵢ(k) denotes a relational coefficient of the k^{th} evaluation index in the i^{th} state, ρₖ is an importance degree of the k^{th} evaluation index and maxᵢΔ denotes a maximum value in the absolute values of differences in the i^{th} state; and
calculating the business damage degree:
$${Degree}_{0 i} = \frac{1}{m} {\sum }_{k = 1}^{m} {w}_{ik} {γ}_{i} ( k )$$
wherein, Degree₀ᵢ denotes the business damage degree in the i^{th} state of the system, and wᵢₖ denotes a weight of the k^{th} evaluation index in the i^{th} state.

13. The non-transitory computer-readable storage medium according to claim 8, wherein the cyber domain updating matrix and the physical domain updating matrix are:
$${T}_{c} = [ \begin{matrix}{w}_{c 11} & ⋯ & {w}_{cn 1} \\ ⋮ & {w}_{cij} & ⋮ \\ {w}_{c 1 n} & ⋯ & {w}_{cnn}\end{matrix} ] \\ {T}_{p} = [ \begin{matrix}{w}_{p 11} & ⋯ & {w}_{pn 1} \\ ⋮ & {w}_{pij} & ⋮ \\ {w}_{p 1 n} & ⋯ & {w}_{pnn}\end{matrix} ]$$
wherein, T_{c} is the cyber domain updating matrix, Tₚ is the physical domain updating matrix, w_{cij} is a cyber domain impact weight between distributed power terminal unit i and distributed power terminal unit j, Wₚᵢⱼ is a physical domain impact weight between the distributed power terminal unit i and the distributed power terminal unit j, and n denotes the number of distributed power terminal units.

14. The non-transitory computer-readable storage medium according to claim 13, wherein update formulas of the cyber domain security risk probability and the physical domain security risk probability are:
$$C = {T}_{c} \cdot {S}_{c} + C \\ P = {T}_{p} \cdot {S}_{p} + P$$
wherein, C is a cyber domain security risk probability matrix of the all distributed power terminal units, P is a physical domain security risk probability matrix of the all distributed power terminal units; S_{c} is a network intrusion matrix, used to indicate whether the distributed power terminal units are subjected to network intrusion; and Sₚ is a physical impact matrix, used to indicate whether the distributed power terminal units are subjected to physical damage.

15. The non-transitory computer-readable storage medium according to claim 8, wherein a searching method for the target attack path is:
taking an attack entrance as a starting point, determining whether a cyber domain security risk probability or a physical domain security risk probability of a distributed power terminal unit connected to a distributed power terminal unit on an attack path exceeds a risk threshold, and in response to the cyber domain security risk probability or the physical domain security risk probability of the distributed power terminal unit connected to the distributed power terminal unit on the attack path exceeds the risk threshold, taking the distributed power terminal unit connected to the distributed power terminal unit on the attack path into the attack path, and setting a state value in a state matrix to 1, that is:
$$\{ \begin{matrix}{s}_{c i} = 1 , if {c}_{i} > {ε}_{c} \\ {s}_{p i} = 1 , if {p}_{i} > {ε}_{p}\end{matrix}$$
wherein, the state matrix comprises a network intrusion matrix and a physical impact matrix;
wherein, the network intrusion matrix is:
$${S}_{c} = [ \begin{matrix}{S}_{c 1} \\ ⋮ \\ {S}_{c n}\end{matrix} ] ;$$
wherein, the physical impact matrix is:
$${S}_{p} = [ \begin{matrix}{S}_{p 1} \\ ⋮ \\ {S}_{p n}\end{matrix} ] ;$$
wherein, Cᵢ is a cyber domain security risk probability of a distributed power terminal unit i, and Pᵢ is a physical domain security risk probability of the distributed power terminal unit i;
wherein, ε_{c} is a cyber domain risk threshold, and εₚ is a physical domain risk threshold;
updating the cyber domain security risk probability or the physical domain security risk probability of the distributed power terminal units through the updated state matrix; and
repeating the operations of taking an attack entrance as a starting point, determining whether a cyber domain security risk probability or a physical domain security risk probability of a distributed power terminal unit connected to a distributed power terminal unit on an attack path exceeds a risk threshold, to the operation of updating the cyber domain security risk probability or the physical domain security risk probability of the distributed power terminal units through the updated state matrix, till the attack path does not continue to change.

16. The non-transitory computer-readable storage medium according to claim 8, wherein a method for assessing a business damage degree comprises:
determining evaluation indexes;
collecting index data of the evaluation indexes for the system in a normal state and index data for the system being inputted with different target attack paths, and values of the collected index data for the system being inputted with different target attack paths are as shown in the following formula:
$$X = ( {X}_{1} , {X}_{2} , … , {X}_{N} ) = [ \begin{matrix}{x}_{1} ( 1 ) & ⋯ & {x}_{n} ( 1 ) \\ ⋮ & ⋱ & ⋮ \\ {x}_{1} ( m ) & ⋯ & {x}_{n} ( m )\end{matrix} ]$$
wherein, X is a system set for the system in different states, N is the number of the different states, m is the number of the evaluation indexes, and Xᵢ is a system index vector in an i^{th} state, as shown in the following formula:
$${X}_{i} = {( {x}_{i} ( 1 ) , {x}_{i} ( 2 ) , … , {x}_{i} ( k ) , … , {x}_{i} ( m ) )}^{T}$$
wherein, xᵢ(k) denotes a value of a k^{th} evaluation index in the i^{th} state;
taking the index data for the system in the normal state as a system reference index vector, and
calculating absolute values of differences between a reference value in the system reference index vector and values of the evaluation indexes in each state,
$$Δ = \vert {x}_{0} ( k ) - {x}_{i} ( k ) \vert , k = 1 , 2 … m , i = 1 , 2 … N \\ {X}_{0} = {( {x}_{0} ( 1 ) , {x}_{0} ( 2 ) , … , {x}_{0} ( k ) , … , {x}_{0} ( m ) )}^{T}$$
wherein, X₀ denotes the system reference index vector, x₀(k) denotes a reference value of the k^{th} evaluation index, xᵢ(k) denotes a value of the k^{th} evaluation index in the i^{th} state;
determining whether xᵢ(k) exceeds an upper limit and a lower limit of a threshold, and in response that x; (k) is within the threshold, writing Δ into a subordinate assessment set;
calculating a relational coefficient of each evaluation index of the evaluation indexes,
$${γ}_{i} ( k ) = \frac{{min}_{i} Δ + {ρ}_{k} \cdot {max}_{i} Δ}{Δ + {ρ}_{k} \cdot {max}_{i} Δ ,} , k = 1 , 2 … m , i = 1 , 2 … N$$
wherein, γᵢ(k) denotes a relational coefficient of the k^{th} evaluation index in the i^{th} state, ρₖ is an importance degree of the k^{th} evaluation index and maxᵢΔ denotes a maximum value in the absolute values of differences in the i^{th} state; and
calculating the business damage degree:
$${Degree}_{0 i} = \frac{1}{m} {\sum }_{k = 1}^{m} {w}_{ik} {γ}_{i} ( k )$$
wherein, Degree₀ᵢ denotes the business damage degree in the i^{th} state of the system, and wᵢₖ denotes a weight of the k^{th} evaluation index in the i^{th} state.
